(19) United States
(12) Patent Application Publication
(10) Pub. No.: US 2020/0049994 A1
(43) Pub. Date: Feb. 13, 2020

(54) TILTED FOCAL PLANE FOR NEAR-EYE DISPLAY SYSTEM

(71) Applicant: Google LLC, Mountain View, CA (US)

(72) Inventors: Ivana TOSIC RODGERS, Mountain View, CA (US); Oscar MARTINEZ, Mountain View, CA (US); Jerome CAROLLO, Mountain View, CA (US)

(21) Appl. No.: 16/102,002

(22) Filed: Aug. 13, 2018

(51) Int. Cl. G02B 27/01; H04N 13/344; H04N 13/128; G02B 27/22

(52) U.S. Cl. CPC G02B 27/0172; H04N 13/344; H04N 13/128; G02B 2027/014; G06T 2207/10028; G02B 2027/0127; G02B 27/22

(57) ABSTRACT

A near-eye display device reduces vergence accommodation conflict by adjusting a tilt and/or distance of a focal plane of a display panel based on scene depth statistics. For example, many three-dimensional (3D) scenes have closer objects in the lower visual field and farther objects in the upper visual field. Changing the tilt of the focal plane of the display panel to match average 3D screen depths reduces the discrepancy between vergence and accommodation distances. In some embodiments, the near-eye display device employs a fixed tilt of the display panel to match average scene depth statistics across a variety of scenes. In some embodiments, the near-eye display device dynamically adjusts the pitch and yaw of the focal plane of the display panel to match scene statistics for a given scene.

### BACKGROUND

Stereoscopic head mounted displays (HMDs) present a pair of stereoscopic images at a fixed distance to a user's eyes. The user's eyes converge at a distance governed by the disparity between the two stereoscopic images (the vergence distance), while the user's eyes focus (i.e., accommodate) to the distance of the physical display (the accommodation distance). These two distances are rarely equal in stereoscopic display viewing. By contrast, in natural viewing, the vergence and accommodation distances are always the same. The discrepancy between the vergence distance and the accommodation distance (referred to as the “vergence accommodation conflict” or VAC) leads to discomfort when wearing an HMD for an extended period of time.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a near-eye display device employing a display focal plane that is adjustably tilted to match scene depth statistics in accordance with some embodiments.

FIG. 2 is a diagram illustrating a vergence and accommodation distance for natural viewing.

FIG. 3 is a diagram illustrating vergence and accommodation distances for stereoscopic display viewing.

FIG. 4 is a depth map of a living room scene.

FIG. 5 is an average depth map across a variety of scenes.

FIG. 6 is a diagram illustrating an adjustable tilt of a display focal plane to reduce vergence accommodation conflict for an average depth map across a variety of scenes in accordance with some embodiments.

FIG. 7 is the average depth map for a bookstore scene.

FIG. 8 is a diagram illustrating an adjustable tilt of a display focal plane to reduce vergence accommodation conflict for a bookstore scene in accordance with some embodiments.

FIG. 9 is a block diagram illustrating a processor for adjusting a tilt of a near-eye display focal plane based on scene depth statistics in accordance with some embodiments.

FIG. 10 is a flow diagram illustrating a method for adjusting a tilt of a near-eye display focal plane based on scene depth statistics in accordance with some embodiments.

### DETAILED DESCRIPTION

The following description is intended to convey a thorough understanding of the present disclosure by providing a number of specific embodiments and details involving adjusting the tilt of a display focal plane of a near-eye display system based on scene depth statistics to minimize a vergence accommodation conflict. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the disclosure for its intended purposes and benefits in any number of alternative embodiments, depending upon specific design and other needs.

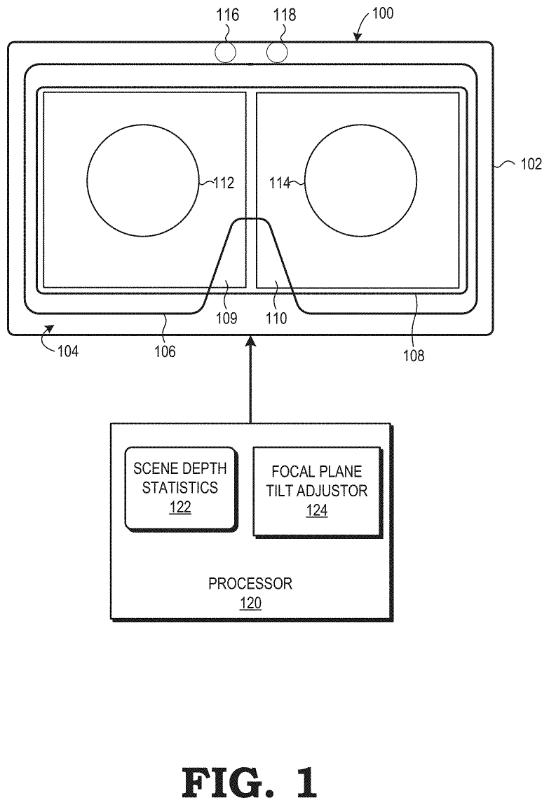

FIGS. 1-10 illustrate example systems and techniques for reducing vergence accommodation conflict in an HMD or other near-eye display system based on adjusting a tilt and/or distance of a display focal plane based on scene depth statistics. Many three-dimensional (3D) scenes have scene depth statistics that conform to a general pattern. For example, many 3D scenes have closer objects in the lower visual field and farther objects in the upper visual field. Changing the tilt of the display focal plane to match average 3D scene depths reduces the discrepancy between vergence and accommodation distances when the near-eye display system is in an environment that conforms to average scene depth statistics.

In at least one embodiment, the near-eye display system averages scene depth statistics for a variety of scenes and determines a degree of rotation of the display focal plane about one or more axes (i.e., pitch and yaw) fitted to the average scene depth statistics. In some embodiments, the near-eye display system employs a fixed tilt of the display focal plane based on the pitch and yaw determined for the average scene depth statistics across a variety of scenes. In some embodiments employing a fixed tilt of the display focal plane, the display panel of the near-eye display system is installed at an angle fitted to the average scene depth statistics. In other embodiments employing a fixed tilt of the display focal plane, the near-eye display system employs a progressive lens in conjunction with the display panel to effectively tilt the focal plane of the display panel to fit the average scene depth statistics.

Some 3D scenes do not have closer objects in the lower visual field and farther objects in the upper visual field. To reduce vergence accommodation conflict for scenes that have scene depth statistics that diverge from the general pattern, in some embodiments, the near-eye display system dynamically adjusts the tilt of the display focal plane based on scene depth statistics for the particular environment displayed at the near-eye display system. In some embodiments, the near-eye display system dynamically adjusts the tilt of the focal plane through adjusting the tilt of the display panel, e.g., using servos mounted between the frame of the HMD and the display panel. In some embodiments, the near-eye display system dynamically adjusts the tilt of the focal plane by employing a lens with a liquid wedge within the optical path of the display light from the display panel, whereby the focal plane tilt increases as the wedge angle of the liquid lens is increased. References herein to adjusting the tilt of the focal plane refer to adjusting the tilt of the display panel itself, or employing a progressive lens in conjunction with the display panel to effectively adjust the tilt of the focal plane of the display panel, or employing a lens with a liquid wedge in conjunction with the display panel to effectively adjust the focal plane of the display panel.

In some embodiments, for example, in video pass-through AR, the near-eye display system employs one or more depth cameras to capture depth images of an environment or scene of the near-eye display system. The near-eye display system captures a set of N depth images of a scene taken from multiple viewpoints that are close to a current viewpoint of the user wearing the HMD. The near-eye display system calculates an average of the N captured depth maps and determines a pitch and yaw of a tilted plane fitted to average scene depth statistics for the scene. The near-eye display system adjusts the tilt of the display focal plane based on the pitch and yaw determined for the average scene depth statistics for the scene. The near-eye display system updates the tilt of the display focal plane by fitting a new depth average for each time interval T. The time interval T varies based on computation performance limitations and hardware speed limitations of the near-eye display system. In some embodiments, the near-eye display system employs one or more stereo cameras to estimate depth maps of an environment of scene of the near-eye display system based on stereoscopic analysis of images captured by the one or more stereo cameras and determines a pitch and yaw of the display focal plane fitted to a subset of depth maps generated based on the stereoscope analysis of images.

Turning now to FIG. 1, an example near-eye display device 100 (also referred to as near-eye display system 100) configured to adjust a pitch and yaw of a display focal plane to fit an average depth map of a scene of the near-eye display device 100 is depicted in accordance with some embodiments. The near-eye display device 100 is illustrated in the example form of a head-mounted display (HMD) device, and thus is also referred to herein as “HMD device 100”. The HMD device 100 is mounted to the head of the user through the use of an apparatus strapped to, or otherwise mounted on, the user's head such that the HMD device 100 is fixedly positioned in proximity to the user's face and thus moves with the user's movements. However, in some circumstances a user may hold a tablet computer or other hand-held device up to the user's face and constrain the movement of the hand-held device such that the orientation of the hand-held device to the user's head is relatively fixed even as the user's head moves. In such instances, a hand-held device operated in this manner also may be considered an implementation of the HMD device 100 even though it is not “mounted” via a physical attachment to the user's head.

The HMD device 100 comprises a housing 102 having a surface 104, a face gasket 106, and set of straps or a harness (omitted from FIG. 1 for clarity) to mount the housing 102 on the user's head so that the user faces the surface 104 of the housing 102. The HMD device 100 further includes a display panel 108 arranged in a landscape orientation, such that the top and bottom pixel rows of the LCD panel appear as the left-most and right-most (or right-most and left-most) pixel “columns” from the perspective of the user when the HMD device 100 is mounted on the user's head. The display panel 108 in conjunction with optics (not shown) form a virtual image at a distance. The plane of the virtual image is referred to herein as the focal plane or display focal plane. In the depicted embodiment, the HMD device 100 is a binocular HMD and thus the display panel 108 is arranged with a left-eye display region 109 and a right-eye display region 110; that is, the display panel 108 is logically divided into left and right “halves.” In some embodiments, the HMD device 100 employs two or more displays. In some embodiments, the display panel 108 is one of an LCD type panel, an OLED panel, a LCOS panel, or other type of display panel. The housing 102 further includes an eyepiece lens 112 aligned with the left-eye display region 109 and an eyepiece lens 114 aligned with the right-eye display region 110.

In some embodiments, the HMD device 100 further includes one or more scene cameras 116 and/or one or more depth cameras 118. The scene cameras 116 can be used to capture stereoscopic image data for the local environment of the HMD device 100. The depth camera 118, in one embodiment, uses a modulated light projector (not shown) to project modulated light patterns from the forward-facing surface of the HMD device 100 into the local environment, and uses the depth camera 118 to capture reflections of the modulated light patterns as they reflect back from objects in the local environment. These modulated light patterns can be either spatially-modulated light patterns or temporally-modulated light patterns. The captured reflections of the modulated light patterns are referred to herein as “depth images.” The depth camera 118 then may calculate the depths of the objects, that is, the distances of the objects from the HMD device 100, based on the analysis of the depth imagery.

The HMD device 100 includes at least one processor 120 configured to determine a pitch and yaw of the display focal plane to match scene depth statistics 122. In some embodiments, the scene depth statistics 122 are based on a dataset, such as depth maps from a rendering engine (z-buffer) including virtual reality (VR) data or from real 3D scene data reflecting scene depths for a variety of scenes. The processor 120 includes a focal plane tilt adjustor 124 configured to calculate an average depth map based on the dataset and fit the focal plane to the average depth map. The focal tilt plane adjustor 124 may be implemented as hard-coded logic of the processor 120, as firmware or programmable logic of the processor 120, as software executed by the processor 120, or a combination thereof. In some embodiments, the focal plane tilt adjustor 124 uses linear regression such as ordinary least squares to fit a first-degree polynomial model to the average depth map and therefore determine parameters of the focal plane tilt. In some embodiments, the tilt of the display focal plane is fixed, and the HMD device 100 employs a tilted display panel 108 having a pitch and yaw to match or approximate the fitting of the display focal plane to the average depth map. In some embodiments, the HMD device 100 employs a progressive lens (not shown) in conjunction with the display panel 108 to visually approximate the fitting of the display focal plane to the average depth map.

In some embodiments, the display focal plane has a variable tilt or bias, such that the display focal plane can be dynamically tilted in one or two directions to match the pitch and yaw of the fitting of the plane to the average depth map. For example, in some embodiments, the HMD device 100 employs a variable wedge liquid lens (not shown) within the optical path of the display light of the display panel 108 that adjusts the tilt of the focal plane. In some embodiments, the HMD device 100 employs a liquid wedge with a zero-power lens (e.g., a liquid-filled variable angle prism) to adjust the tilt (pitch and/or yaw) of the display focal plane. In embodiments employing a variable tilt display focal plane, the focal plane tilt adjustor 124 dynamically adjusts the tilt of the display focal plane to approximate the average depth map or other scene depth statistics 122.

In some embodiments, the scene depth statistics 122 are based on average scene depths for a specific scene. In some embodiments, the scene depth statistics 122 are based on a set of N depth images captured by the depth camera 118. For example, in some embodiments, the scene depth statistics 122 are based on one or more current depth images captured by the depth camera 118. In some embodiments, the scene depth statistics 122 are based on an average depth map for the previous N frames of depth images captured by the depth camera 118. In some embodiments, the scene depth statistics 122 are based on an average depth map for depth images captured by the depth camera 118 during a previous increment of time T.

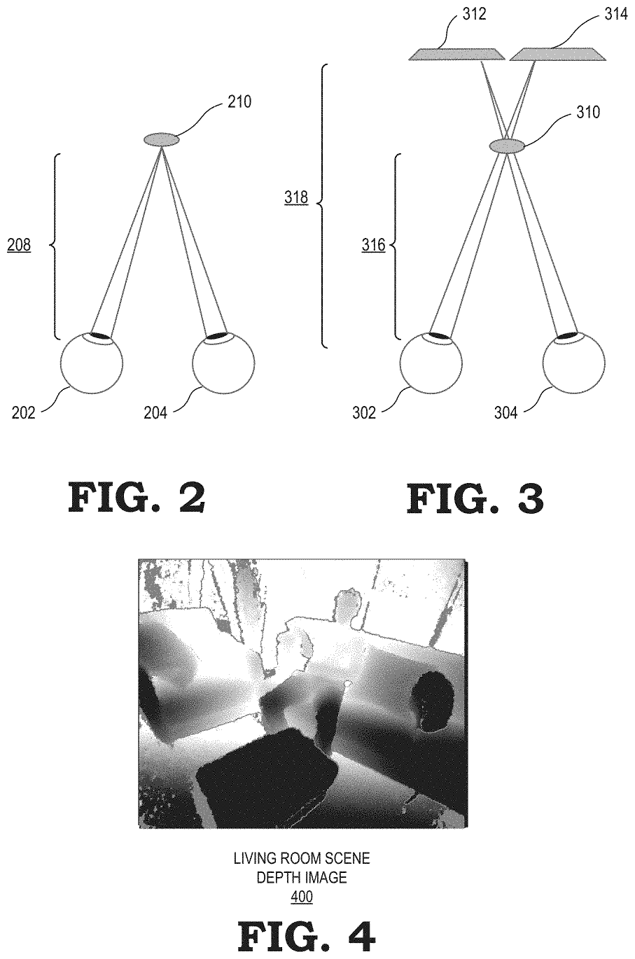

FIG. 2 illustrates a vergence and accommodation distance 208 for natural viewing. When viewing an object under real-world viewing conditions, the oculomotor cues that govern the focus action of the eye where the shape of the lens is adjusted to see objects at different depths (accommodation) and the convergent rotation of the eyes where the visual axes are brought to intersect at a 3D object in space (vergence) are tightly coupled, such that the convergence distance coincides with the accommodation distance. For example, as illustrated in FIG. 2, left eye 202 and right eye 204 are focused on an object 210. The vergence and accommodation coincide at a distance 208.

By contrast, as illustrated in FIG. 3, when viewing a virtual object 310 at a near-eye stereoscopic display having a left eye focal plane 312 and a right eye focal plane 314, the left eye 302 and right eye 304 converge at a distance 316 governed by the disparity between the two stereoscopic images displayed at the left eye focal plane 312 and the right eye focal plane 314, respectively. However, the left and right eyes 302, 304 accommodate at a distance 318 of the focal planes 312, 314 of the physical display. The difference between the vergence distance 316 and the accommodation distance 318 (the vergence accommodation conflict) causes discomfort to users of stereoscopic displays.

FIG. 4 is a depth map 400 of a living room scene. The living room scene includes a floor and coffee table in the lower portion of the scene, with a sofa behind the coffee table in the middle portion of the scene. The upper portion of the living room scene includes windows behind the coffee table and sofa. The depth map 400 of the living room scene indicates that closer (darker) areas are concentrated in a lower portion of the field of view, whereas farther (lighter) areas are concentrated in an upper portion of the field of view.

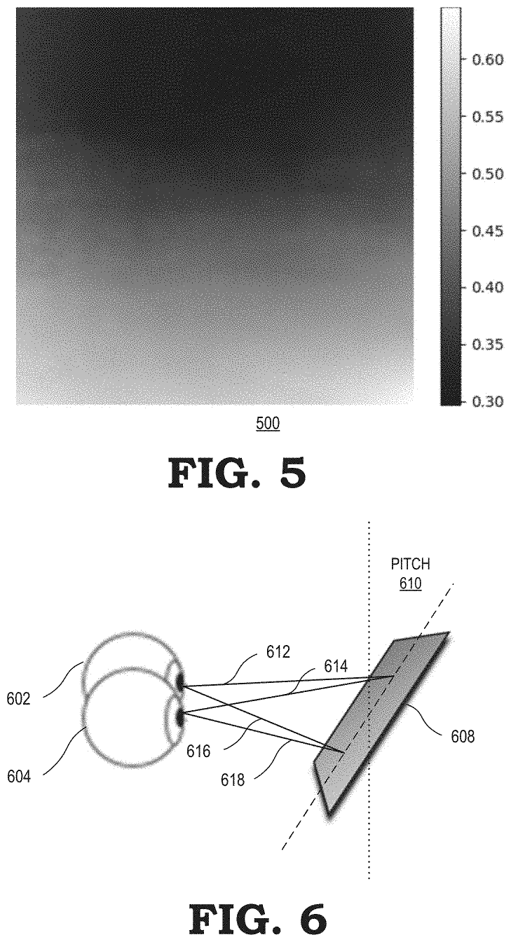

FIG. 5 is an average depth map 500 across a variety of scenes based on depth maps available from the NYU Depth Dataset V2, Indoor Segmentation and Support Inference from RGBD Images ECCV 2012 (“NYU Depth Dataset V2”). The scale of the average depth map is indicated in diopters (1/m), with closer objects shown in lighter shades and farther objects shown in darker shades. The average depth map 500 indicates that, on average, closer objects are located at the lower portion of the field of view, and farther objects are located at the upper portion of the field of view.

FIG. 6 illustrates an adjustable tilt of a display focal plane 608 to reduce vergence accommodation conflict in accordance with some embodiments. In some embodiments, the tilt of the display focal plane 608 is achieved by physically tilting a display panel. In some embodiments, the tilt of the display focal plane 608 is achieved by employing a progressive lens (not shown) in conjunction with the display panel. In some embodiments, the tilt of the display focal plane 608 is achieved by employing a lens and liquid wedge within the optical path of the display light from the display panel.

The display focal plane 608 is tilted to a pitch and yaw angle 610 to match or approximate scene depth statistics. In the illustrated example, the scene depth statistics indicate that closer objects are in the lower visual field and farther objects are in the upper visual field. Accordingly, the display focal plane 608 is tilted such that the upper portion of the display focal plane 608 is farther from a user's eyes 602, 604, and the lower portion of the display focal plane 608 is closer to the user's eyes 602, 604. Thus, when the user focuses on an object in the upper portion of the display focal plane 608, the left eye 602 focuses at a distance 612 and the right eye 604 focuses at a distance 614. By contrast, when the user focuses on an object in the lower portion of the display focal plane 608, the left eye 602 focuses at a distance 616, which is shorter than distance 612, and the right eye 604 focuses at a distance 618, which is shorter than distance 614. By tilting the display focal plane 608 to match the scene depth statistics, a near-eye display reduces the discrepancy between the vergence and accommodation distances by having the user's eyes focus, on average, at farther distances for farther objects and at closer distances for closer objects.

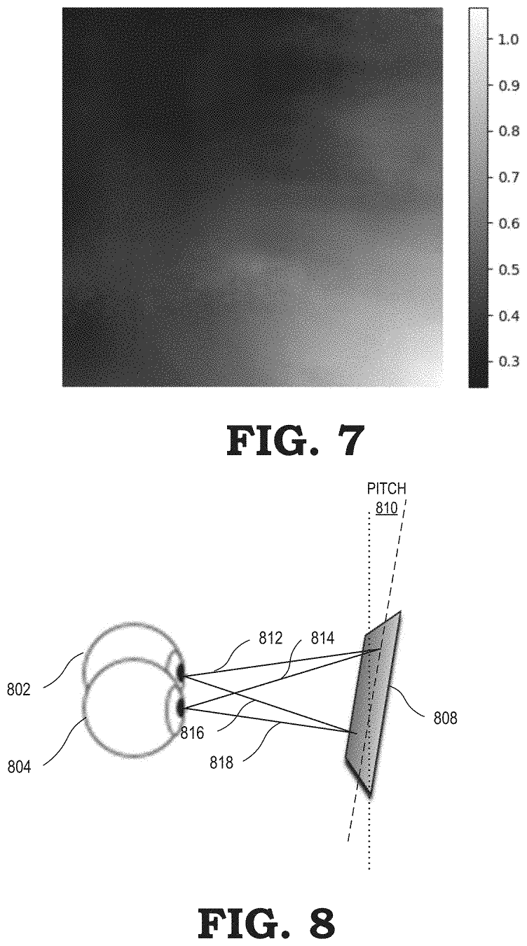

FIG. 7 depicts an average depth map 700 for a bookstore scene based on depth maps available from the NYU Depth Dataset V2. The scale of the average depth map 700 is indicated in diopters (1/m), with closer objects shown in lighter shades and farther objects shown in darker shades. The average depth map 700 for the bookstore scene differs from the average depth map 500 of FIG. 5 in that, on average, closer objects are located at the lower portion right of the field of view, and farther objects are located at the upper left portion of the field of view. Thus, the yaw and pitch of a display focal plane fitted to match the depth statistics of the bookstore scene differ from the yaw and pitch of a display focal plane fitted to match the average depth statistics for a variety of scenes.

FIG. 8 illustrates an adjustable tilt of a display focal plane 808 to reduce vergence accommodation conflict for the bookstore scene 700 of FIG. 7 in accordance with some embodiments. The display focal plane 808 is tilted to a pitch and yaw angle 810 to match or approximate scene depth statistics. In some embodiments, the tilt of the display focal plane 808 is achieved by physically tilting the display panel. In some embodiments, the tilt of the display focal plane 808 is achieved by employing a progressive lens (not shown) in conjunction with the display panel. In some embodiments, the tilt of the display focal plane 808 is achieved by employing a lens and liquid wedge in conjunction with the display panel.

The display focal plane 808 is tilted to a pitch and yaw angle 810 to match or approximate scene depth statistics for the bookstore scene 700. In the illustrated example, the scene depth statistics indicate that closer objects are in the lower right visual field and farther objects are in the upper left visual field. Accordingly, the display focal plane 808 is tilted such that the upper portion of the display focal plane 808 is farther from a user's eyes 802, 804, and the lower portion of the display focal plane 808 is closer to the user's eyes 802, 804. Thus, when the user focuses on an object in the upper portion of the display focal plane 808, the left eye 802 focuses at a distance 812 and the right eye 804 focuses at a distance 814. By contrast, when the user focuses on an object in the lower portion of the display focal plane 808, the left eye 802 focuses at a distance 816, which is shorter than distance 812, and the right eye 804 focuses at a distance 818, which is shorter than distance 814. However, because the scene depth statistics of the bookstore scene 700 differ from the scene depth statistics of the average scene depth across a variety of scenes 500, the differences between the distances 816 and 812, and 818 and 814, are smaller than the differences between the distances 616 and 612, and 618 and 614 shown in FIG. 6, respectively. By tilting the display focal plane 808 to match the scene depth statistics, a near-eye display reduces the discrepancy between the vergence and accommodation distances by having the user's eyes focus, on average, at farther distances for farther objects and at closer distances for closer objects.

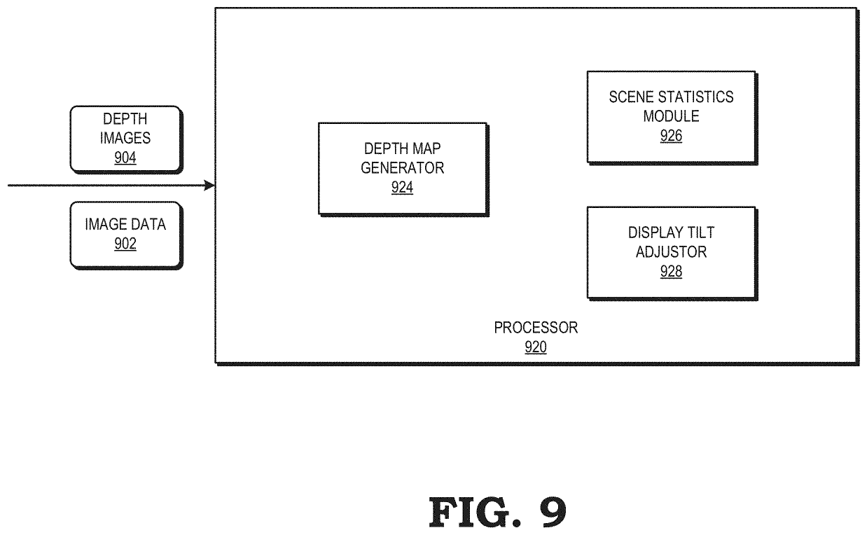

FIG. 9 is a block diagram illustrating a processor 920 for adjusting a tilt of a near-eye display focal plane of the HMD device 100 of FIG. 1 based on scene depth statistics in accordance with some embodiments. The processor 920 includes a depth map generator 924, a scene statistics module 926, and a display tilt adjustor 928. Each of these components may be implemented as hard-coded logic, programmable logic, software executed by the processor 920, or a combination thereof.

In the depicted example, the processor 920 receives depth images 904 from the depth camera 118. The depth map generator 924 receives depth images 904 from the depth camera 118. In some embodiments, the depth map generator 924 receives stereoscopic image data 902 from the image cameras 116. The depth map generator 924 may be implemented as hard-coded logic of the processor 920, as firmware or programmable logic of the processor 920, as software executed by the processor 920, or a combination thereof. The depth map generator 924 calculates depth maps based on the depth images 904 or the stereoscopic image data 902. In some embodiments, the depth map generator 924 calculates a depth map for each frame of depth images 904 captured by the depth camera 118. In some embodiments, the depth map generator 924 calculates an average depth map for a number of previous frames of depth images 904 captured by the depth camera 118. In some embodiments in which the depth map generator 924 calculates a depth map of the scene of the HMD device 100, the display tilt adjustor 928 determines a tilt of the display panel 108 to match or approximate the statistics of the depth map of the scene.

The scene statistics module 926 calculates average scene depth statistics for the scene based on depth maps obtained from a VR rendering engine z-buffer, in VR systems, or based on depth maps generated by the depth map generator 924 for pass-through AR systems. In general, most 3D scenes have closer objects in the lower visual field and farther objects in the upper visual field. However, some 3D scenes have average scene depths that are tilted in different directions. By calculating average scene depth statistics for the particular scene being viewed, the processor 920 dynamically selects scene statistics that match the particular scene of the HMD device 100.

The display tilt adjustor 928 dynamically maps from the tilt values of the scene statistics to the corresponding tilt needed for the display panel such that the tilt of the display focal plane matches the scene statistics calculated by the scene statistics module 926. The mapping between the tilt values of the scene statistics and the tilt of the display panel for the tilt of the display focal plane to match the scene statistics is based on the optics of the HMD. For example, if the scene statistics selected by the scene statistics module 926 indicate that closer objects are in the lower left visual field and farther objects are in the upper right visual field, the display tilt adjustor 928 tilts the display panel 108 such that the lower left portion of the display panel 108 is closer to the user and the upper right portion of the display panel 108 is farther from the user. In some embodiments, the display tilt adjustor 928 additionally or alternatively adjusts the distance of the display panel 108 from the user based on the selected scene statistics. In addition, the field of view and scene depth statistics of the HMD device 100 vary based on an application executing at the HMD device 100. Accordingly, in some embodiments, the display tilt adjustor 928 adjusts one or more of the pitch, yaw, and distance of the display panel 108 based on the expected scene statistics of the application executing at the HMD device 100.

In some embodiments, the display tilt adjustor 928 mechanically adjusts the tilt of the display panel 108, e.g., using servos mounted between the frame of the HMD 100 and the display panel 108, based on the selected scene statistics. In some embodiments, the display tilt adjustor 928 adjusts the tilt of the focal plane of the display panel 108 by employing a lens with a liquid wedge in conjunction with the display panel 108, whereby the display tilt adjustor 928 increases the tilt of the focal plane as more wedge is introduced. The display tilt adjustor 928 re-adjusts the tilt of the display panel 108 based on a change in the scene depth statistics (e.g., if a different scene is displayed at the HMD device 100). In some embodiments, the tilt of the display panel 108 is fixed, and the display tilt adjustor 928 determines a tilt of the display panel 108 based on average scene depth statistics across a variety of scenes. In some embodiments in which the tilt of the display panel 108 is fixed, the HMD device 100 employs a progressive lens having, for example, a different power at the lower portion of the lens than the power at the upper portion of the lens, to match the average scene depth statistics across a variety of scenes.

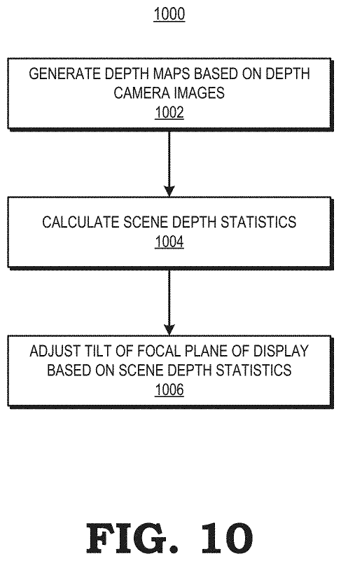

FIG. 10 is a flow diagram illustrating a method for adjusting a tilt of focal plane of a near-eye display panel 108 of FIG. 1 based on scene depth statistics in accordance with some embodiments. At block 1002, the depth map generator 924 generates one or more depth maps based on images captured by the depth camera 118 or stereoscopic images captured by the image cameras 116. In some embodiments, the depth maps are obtained from a rendering engine. At block 1004, the scene statistics module 926 calculates average scene depth statistics for the scene based on the depth maps. At block 1006, the display tilt adjustor 928 adjusts the tilt of the focal plane of the display panel 108 based on the average scene depth statistics and/or the depth map generated by the depth map generator 924.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
determining scene depth statistics for a scene in an environment displayed at a near-eye display device;
determining at least one angle of a focal plane of the near-eye display device that reduces a discrepancy between accommodation and vergence distances for a user of the near-eye display device based on the scene depth statistics; and
adjusting a tilt of the focal plane of the near-eye display device based on the at least one angle.

2. The method of claim 1, wherein the scene depth statistics comprise an average depth map for a plurality of scenes.

3. The method of claim 2, wherein determining the angle of the focal plane of the near-eye display device comprises fitting the focal plane to the average depth map for the plurality of scenes.

4. The method of claim 1, wherein the scene depth statistics are based on depth maps obtained from a virtual reality rendering engine.

5. The method of claim 1, further comprising:
generating depth maps of the scene based on depth images captured by one or more depth cameras of the near-eye display device; and
wherein the scene depth statistics comprise an average of a subset of the generated depth maps.

6. The method of claim 1, wherein determining the angle of the focal plane is further based on scene depth statistics of an application being executed at the near-eye display device.

7. The method of claim 1, wherein adapting the tilt comprises dynamically adapting at least one of a pitch and yaw of the focal plane of the near-eye display device.

8. The method of claim 1, further comprising:
adjusting a distance of the focal plane from the user's eyes based on the scene depth statistics.

9. A method, comprising:
calculating an average depth map of a scene of a near-eye display device;
determining parameters to fit a plane to the average depth map of the scene; and
tilting a focal plane of a display of the near-eye display device based on the parameters to reduce a discrepancy between accommodation and vergence distances for a user of the near-eye display device.

10. The method of claim 9, wherein the average depth map comprises an average depth map for a plurality of scenes.

11. The method of claim 9, wherein the average depth map is based on depth maps obtained from a virtual reality rendering engine.

12. The method of claim 9, further comprising:
generating depth maps of the scene based on depth images captured by one or more depth cameras of the near-eye display device; and
wherein the average depth map comprises an average of a subset of the generated depth maps.

13. The method of claim 9, wherein determining the parameters is further based on scene depth statistics of an application being executed at the near-eye display device.

14. The method of claim 9, wherein tilting the focal plane comprises dynamically adapting at least one of a pitch and yaw of the focal plane of the display.

15. The method of claim 9, wherein tilting the focal plane comprises adjusting a liquid-filled variable wedge lens within an optical path of light from a display panel of the near-eye display device.

16. A device, comprising:
a near-eye display device comprising a display panel; and
a processor configured to:
determine scene depth statistics for a scene in an environment of the near-eye display device;
determine at least one angle of a focal plane of the display panel of the near-eye display device that reduces a discrepancy between accommodation and vergence distances for a user of the near-eye display device based on the scene depth statistics; and
adjust a tilt of the focal plane of the display panel of the near-eye display device based on the angle.

17. The device of claim 16, wherein the scene depth statistics comprise an average depth map for a plurality of scenes.

18. The device of claim 16, wherein the processor is to determine the angle of the focal plane of the display panel by fitting the focal plane to an average depth map for a plurality of scenes.

19. The device of claim 16, wherein the scene depth statistics are based on depth maps obtained from a virtual reality rendering engine.

20. The device of claim 16, wherein:
the near-eye display device further comprises one or more depth cameras; and
the processor is further configured to:
generate depth maps of the scene based on depth images captured by the one or more depth cameras of the near-eye display device; and
wherein the scene depth statistics comprise an average of a subset of the generated depth maps.
